(19) United States
(12) Patent Application Publication
(10) Pub. No.: US 2009/0110337 A1
(43) Pub. Date: Apr. 30, 2009

(54) Fluid bearing having improved wear properties

(76) Inventors: Lei Jiang, Villingen-Schwenningen-Herzogenweiler (DE); Martin Bauer, Villingen-Schwenningen (DE); Huseyin Taner Baytekin, Villingen-Schwenningen (DE)

Correspondence Address: COOPER & DUNHAM, LLP, 30 Rockefeller Plaza, 20th Floor, NEW YORK, NY, 10112, US

(21) Appl. No.: 12/290,261

(22) Filed: Oct. 29, 2008

(30) Foreign Application Priority Data
Oct. 30, 2007 (DE) 10 2007 051 774.4

(51) Int. Cl. F16C 32/06

(52) U.S. Cl. 384/120

(57) ABSTRACT

A radial fluid bearing having improved wear properties in the operating state of start-up and run-down, the bearing pattern being formed in the region between a bearing bush and a shaft engaging through the bearing bush and consisting of a plurality of grooves disposed at a distance from one another, characterized in that at least the groove depth of the radial bearing is made smaller than that of the prior art, a groove depth of less than 3 micrometers being preferred.

The invention relates to a fluid bearing having improved wear properties according to the preamble of patent claim 1.

Fluid bearings are generally utilized in miniature motors, such as in fans or in spindle motors for driving hard disks.

It is known to design this kind of fluid bearing as an axial bearing or as a radial bearing. As a rule, one or two axial bearings are disposed at a mutual distance from one another. Moreover, at least one radial bearing is provided at a distance to the axial bearings.

A serious problem involved here is that on start-up and run-down of this kind of fluid bearing, the necessary (operating) time is undesirably long. The difficulty is that in these operating states, the bearing is no longer load-carrying because the fluid film breaks down. There is then the disadvantage that in these operating states undesired wear occurs. Abraded particles are carried into the oil, and in the long term, may result in galling and thus in a shorter useful life of the bearing.

In terms of production engineering, there is the further disadvantage for bearings having a relatively large groove depth for their radial bearing grooves that through non-cylindrical deviations in the bearing bore (taper) and through imprecise fabrication of the pumping patterns (erosion), the pumping patterns generate undesirable distributions of pressure. In particular, this could result in the unintentional weakening or strengthening of a pumping direction that is necessary for the bearing function and exerted on the bearing fluid in an axial direction by the pumping patterns. This in turn could give rise to the problem, particularly in the region of a deepened bearing gap, in the separator region between the upper and the lower radial bearing as well as in the transition region between a radial bearing and an adjacent axial bearing, of negative pressure zones being created, which again could result in the out-gassing of dissolved air contained in the bearing fluid. When a sufficient amount of air has been collected, the opposing bearing surfaces could come into mechanical contact that could in turn lead to the failure of the bearing system. Undesirable bearing conditions particularly occur when these undesired distributions of pressure actually result in negative pressure zones in which air is incorporated, so that the bearing pattern no longer carries a load. This goes to impair the overall load-carrying capacity of the bearing.

To date it is known to provide radial bearings with an average groove depth in the region of approximately 3 to 7 micrometers. Apart from the fact that the manufacture of such a defined depth is relatively complex and expensive, the above-mentioned disadvantage pertains to these kinds of bearings having such groove depths.

The invention therefore has the object of providing a fluid bearing having improved wear properties in which there is lower wear particularly at start-up and at run-down.

In achieving this object, the invention is characterized by the technical teaching of claim 1.

An important characteristic of the invention is that, according to the invention, at least the groove depth of the radial bearing is made smaller than that of the prior art, a groove depth being preferred that is smaller than the average bearing gap in the region of the radial bearing.

The disclosed technical teaching gives rise to the important advantage that a radial bearing is proposed in which the groove depth is made significantly smaller than the groove depth in the prior art. This involves a decrease to at least half, if not up to a third, of known groove depths, thus giving the radial bearing a greater load-carrying capacity. In a preferred embodiment, the groove depth is in the region of less than 3 micrometers, most preferably in the region of less than 1 to 2 micrometers and greater than 0 micrometers.

Incidentally, in realizing the invention it does not matter on what parts of the bearing the bearing pattern is disposed. The radial bearing pattern having grooves of a lesser depth may be disposed either in the region of the shaft and/or in the region of the bearing bush.

Here, it is assumed that the width of the groove substantially corresponds to that of the prior art, with only the groove depth and/or the length of the bearing patterns being made significantly smaller in the radial bearing according to the invention. Typical groove widths in the prior art are approximately 100 to 250 micrometers.

Here, it is preferable if the distance between the bearing pattern not influenced by grooves and the surface of the shaft, i.e. the bearing gap width, is set in relation to the claimed groove depth.

Here, it is preferable if this groove depth is smaller than the bearing gap width. The change in the groove depth of the fluid bearing according to the invention influences the frequency response of the motor.

In a further aspect of the invention, it will be described that the average pattern depth of the radial bearing grooves, which is defined as the quotient of the sum of the volume of all the radial bearing grooves divided by the radial bearing surface, is less than a micrometer, preferably even less than half a micrometer. The term “radial bearing surface” is understood to mean the region of the narrow radial bearing gap including any non-grooved region, the quiet zone, axially adjoining the grooved region, but excluding a region having a deeper radial bearing gap, such as the separator region, that is generally located between two radial bearings, and also excluding a narrow bevel or chamfer adjoining the narrow radial bearing gap that leads into a deeper radial bearing region.

Although the decrease in the groove depth or the average pattern depth of the radial bearing grooves according to the invention does worsen the transfer function in the low-frequency range, this function is improved, however, in the high frequency range.

The term “transfer function” is here understood to mean the relative deflection of the storage disk in the direction of the fixed frame of the storage disk, and that as a function of the excitation frequency.

The worsening of the transfer function of a storage disk in the low-frequency range of between 100 to 200 Hz may be compensated using electronic means and thus is of no importance for the reduction in the groove depth. The invention makes use of this insight. A decrease in the groove depth has to date been dismissed by the prior art for this reason.

What is important, however, is that with the decrease in the groove depth according to the invention, the transfer function in the higher frequency range of somewhere between 1,000 to 2,000 Hz is greatly improved, by means of which the acoustic emissions of a motor having such a bearing are reduced within this frequency range. Any shocks that occur within this frequency range no longer disturb the read/write operation, which was not the case in the prior art.

The decreased groove depth according to the invention in the region of the (or of several) radial bearing(s) gives rise to the important advantage that at start-ups and run-downs of the bearing, there is a shorter lift-off or drop-down process, i.e. a shorter time within which the bearing begins to become load-carrying. This lift-off time is greatly shortened and wear is thus reduced to a significant extent. This basically goes to ensure that the bearing patterns subject to wear at start-up have a much smaller contact length with the opposing stationary bearing patterns, by means of which wear is significantly reduced and the useful life of the bearing thus considerably increased.

These conditions apply in the same way to the run-down behavior of this kind of fluid bearing. Here again, a longer time is spent in which the bearing is load carrying and there is only a relatively short time (or short distance) in which the bearing is no longer load-carrying, and any wear occurring in this region is thus greatly reduced.

The start-up behavior of this kind of bearing is described in more detail below:

Since on start-up with an unchanged electromotive drive, the same start-up torque is always exerted on the fluid bearing, lift-off of the bearing occurs at a specific rotational speed, i.e. the bearing patterns become load-carrying after a specific start-up time. In the prior art, the rotational speed at which lift-off of the shaft takes place is necessarily greater than for the present invention, since the larger groove depths first take up fluid before the load-carrying capacity kicks in. The realization of the present invention (decreasing the groove depth or the average pattern depth of radial bearings) gives rise to the important advantage that the manufacturing process can be made much shorter and consequently more cost-effective, and it may also achieve a higher quality, because considerably fewer side effects are produced, such as erosion, which can occur in the electrochemical manufacture of grooves of considerable depth.

As a means of visualizing the function of the present invention, the concept of aquaplaning can be used. It is well-known that tires with less tread depth experience a floating effect on road surfaces covered with a layer of water. The aim of the present invention is to create this aquaplaning effect and that is why it is important for the radial bearing to have such a small groove depth that this kind of aquaplaning effect takes place as soon as possible after start-up of the motor.

The groove depth aspired to by the invention should thus be deeper than the natural roughness produced by the manufacturing process, so as to actually create a radial bearing load-carrying capacity. The roughness Rₐ of the bearing bore is generally less than 0.5 micrometers.

The subject matter of the present invention is not only derived from the subject matter or the individual patent claims, but also from the combination of the individual patent claims.

All the details and characteristics revealed in the documents, including the abstract, particularly the spatial designs illustrated in the drawings, are claimed to be essential to the invention to the extent that they are new either individually or in combination with respect to the prior art.

The invention is described in more detail below on the basis of the drawings showing only one embodiment approach. Further characteristics and advantages essential to the invention can be derived from the drawings and their description.

The figures show:

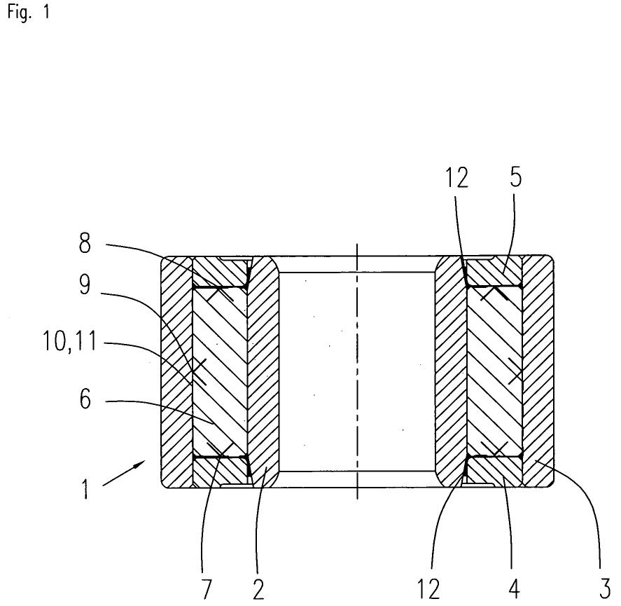

FIG. 1: a section through a bearing having a conventional construction

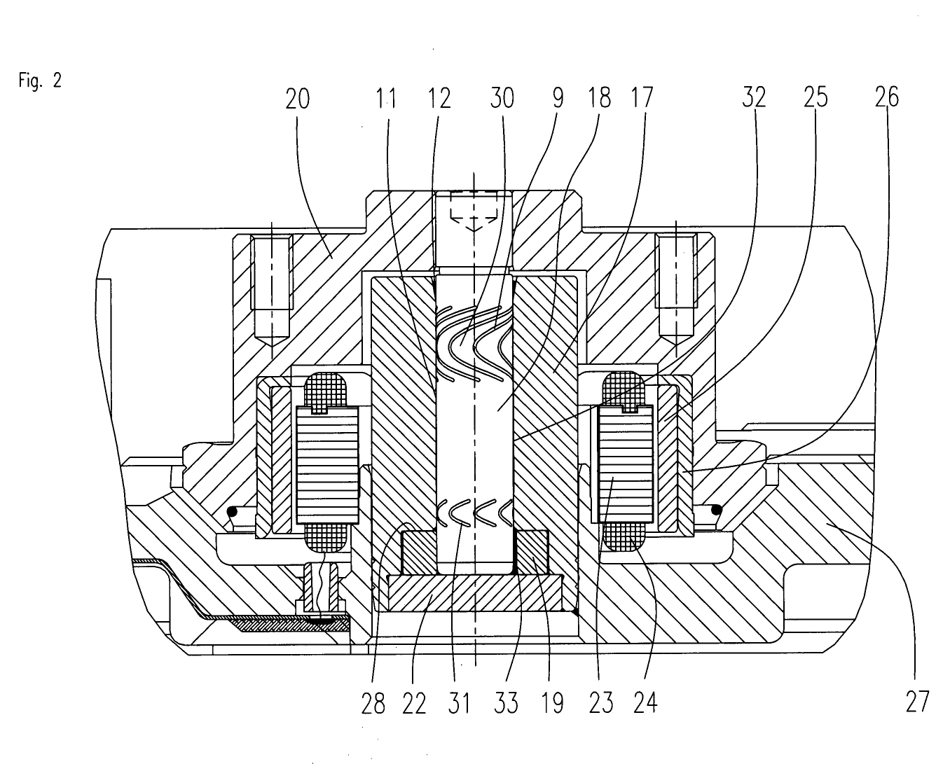

FIG. 2: a bearing pattern of a bearing having an attached motor and showing an irregular bearing pattern for a radial bearing

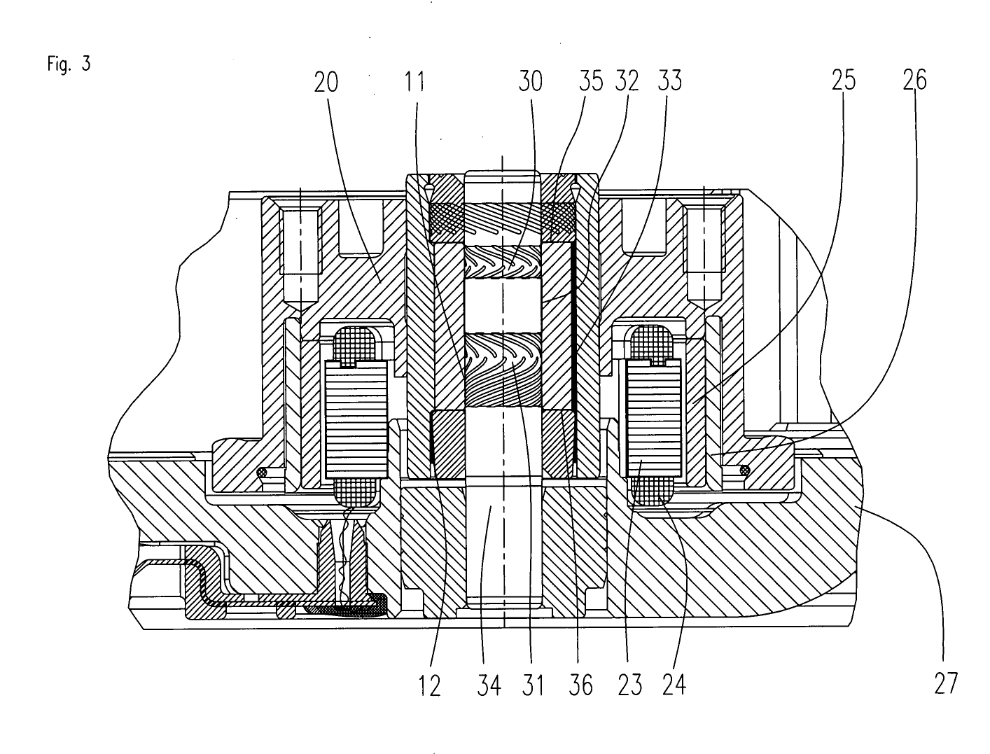

FIG. 3: shows a double axial fluid bearing having a stationary shaft and an appropriate drive system

FIG. 4: a bearing having differently designed radial bearings

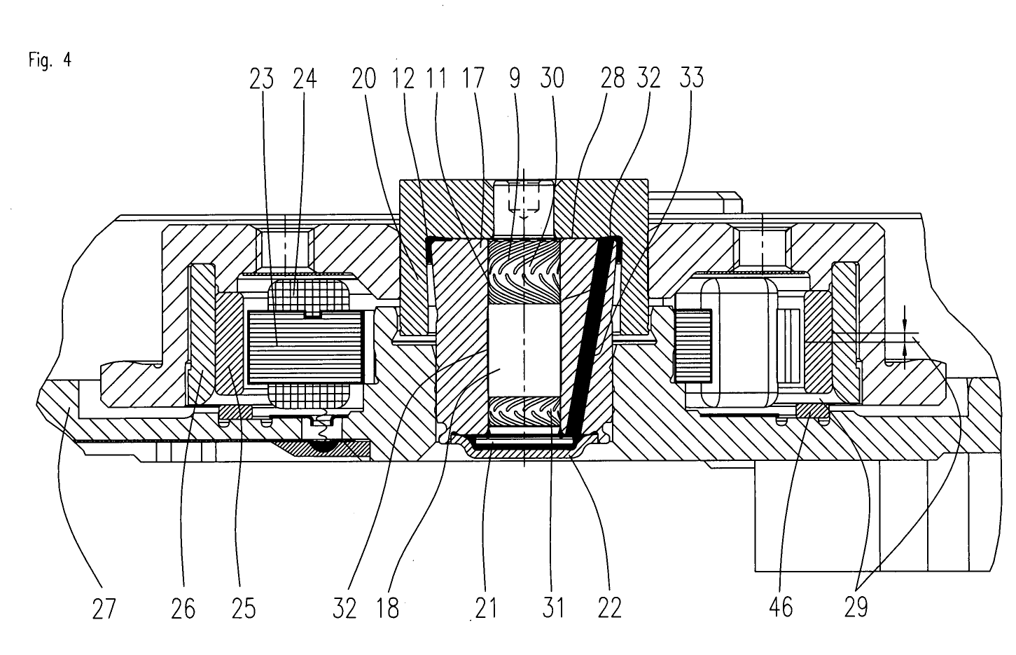

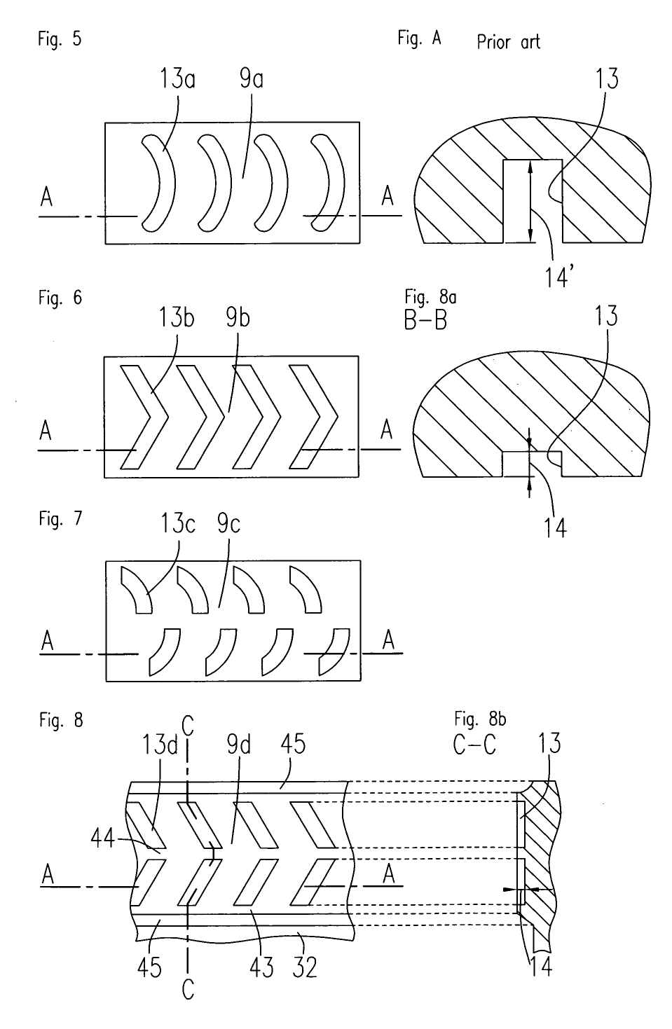

FIG. 5: a developed view of a radial bearing having a first bearing pattern

FIG. 6: a developed view of a radial bearing having a second bearing pattern

FIG. 7: a developed view of a radial bearing having a third bearing pattern

Figure A: the groove depth of a radial bearing belonging to the prior art

FIG. 8a: the groove depth of a bearing according to the invention

FIG. 8b: the height profile of the radial bearing according to FIG. 6

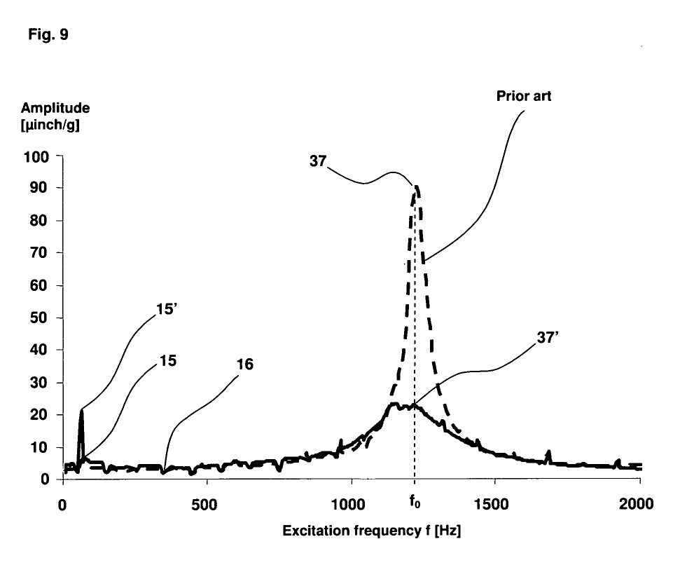

FIG. 9: the transfer function of a hard disk with the relative deflection of the storage disk normalized to acceleration shown on the y-coordinate as a function of the excitation frequency that externally excites the system into radial vibrations.

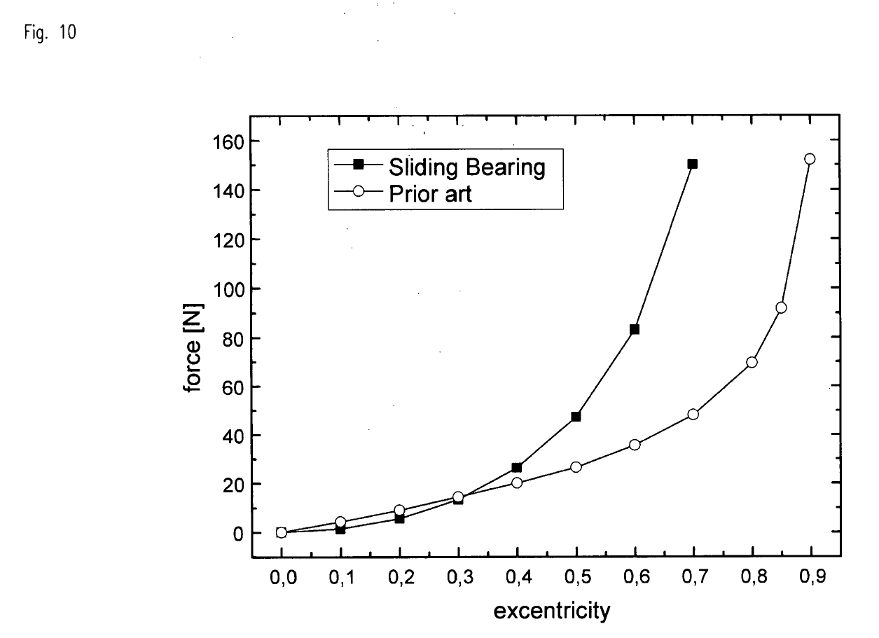

FIG. 10: the comparison of a radial bearing having a decreased groove depth to a fluid bearing as a function of the load-carrying capacity of a bearing and the eccentricity of the shaft

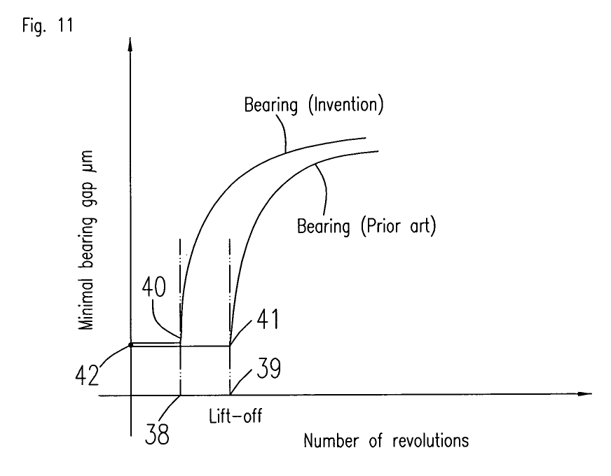

FIG. 11: the dependence of the rotational speed as from the load-carrying capacity of the bearing on the minimum bearing gap in relation to different groove depths of the radial bearing patterns

In FIG. 1, a basic bearing 1 is shown that consists of an inner bearing ring 2 that is designed either to rotate or to be stationary. Here, the inner bearing ring 2 forms a central recess through which, for example, a shaft or a hub engages.

The inner bearing ring 2 is fixedly connected to a middle bearing ring 6, together with which the opposing outer bearing ring 3 forms several different bearings.

In the region between the upper and lower axial bearing plate 4, 5, the two axial bearings 7, 8 are formed.

The radial bearing 10 according to the invention is formed in the radially outwards directed region of the middle bearing ring 6 in the radial region in the direction of the outer bearing ring 3. In the region of this radial bearing 10, the radial bearing gap 11 is formed in a well-known manner.

By way of example, the radial bearing 10 shows a bearing pattern 9 that may take the modified forms as illustrated in FIGS. 5 to 7.

FIG. 2 shows a different bearing pattern for a bearing, the bearing pattern 9 of the radial bearing being irregularly formed and consisting of an upper bearing pattern and a lower bearing pattern disposed asymmetrically thereto. The bearing patterns are each sinusoidal in design.

The bearing pattern 9 is thus formed from an upper radial bearing 30 and a lower radial bearing 31. The two radial bearings are disposed in the region of a bearing bush 17, a shaft 18 engaging through the bearing bush 17.

The shaft 18 is driven in rotation. The rotary drive of the shaft 18 is effected here via the hub 20, which is connected via the rotor back yoke 26 to a rotor magnet 25. A fluid axial bearing is denoted by 28.

The bearing is sealed from below by a cover plate 22 and a recirculation channel 33 is provided in the lower region that establishes a connection between axial bearing 28 and the axial bearing disposed in the region of the cover plate 22.

The stator unit 23 has a coil winding 24 and is connected to the baseplate 27.

FIG. 3 shows a similar bearing pattern, an upper radial bearing 30 again being disposed at a distance to a lower radial bearing 31 and a separator region 32 being provided in between. The separator region 32 is filled with fluid and forms a larger bearing gap than the bearing gap in the region of the radial bearings 30, 31, so as to minimize frictional losses in this region.

An upper axial bearing 35 is disposed opposite a lower axial bearing 36.

Otherwise the same reference numbers apply to the identical parts mentioned with reference to FIG. 2.

FIG. 4 shows a further bearing, the axial bearing formed in the region of the cover plate 22 and shown at the bottom in FIG. 2, now being moved to the top in the region between the upper surface of the bearing bush and the underside of the hub. In addition to the fluid dynamic axial bearing 28, a magnetic counter axial bearing 29 is formed by an axial magnetic offset of the rotor magnet 25 and the stator unit 23 with respect to each other, and, as an alternative or in addition, by a ferromagnetic ring 46 (attractive plate) fixed to the baseplate axially below the rotor magnet.

Two radial bearings are again provided that form asymmetric bearing patterns 9, the upper radial bearing being denoted by 30 and the lower by 31. The two radial bearings 30, 31 are separated from one another by the separator region 32.

The rotating shaft 18 is fixedly connected to the hub 20. The limiting ring 21 is there to prevent the shaft 18 from falling out of the top. An axial bearing 28 is disposed in the region between the upper surface of the bearing bush 17 and the underside of the hub 20. The axial bearing 28 consists of a radially inner part having a narrow axial bearing gap and a radially outer part that has a widened bearing gap and adjoins a capillary seal 12 which is formed between the outside circumference of the bearing bush 17 and the opposing inner wall of the hub 20. A recirculation channel 33 connects the underside of the shaft 18 to the radially outer part of the axial bearing 28. This recirculation channel 33, however, can be preferably omitted, since, due to the smaller groove depth of the radial bearings 30, 31, a slight tapered deviation in the bearing bore in the region of the radial bearings results in a smaller pressure divergence from the required pressure profile than would be the case in the prior art.

A capillary seal 12 is also provided in the embodiments.

In FIGS. 5 to 8 various bearing patterns for the radial bearings are illustrated.

The bearing patterns are denoted by the letters a, b, c and d. The bearing groove 13a in FIG. 5 is designed approximately sinusoidal, whereas the bearing groove 13b according to FIG. 6 is given a herringbone pattern, the bearing pattern 13c in FIG. 7 has half sinusoidal curves that are disposed at an offset to one another and the bearing pattern 13d in FIG. 8 largely corresponds to the pattern in FIG. 6, the mid-section, however, having no grooves which means that the bearing patterns consist of a plurality of paired lines oriented towards each other but not joined together.

A section through a bearing pattern in accordance with section A-A in FIGS. 5 to 8 gives the new groove design according to the invention of the bearing groove 13a-13c. The difference to the prior art is made clear when compared to figure A.

Figure A shows that the average depth of the bearing groove, that is given as groove depth 14, is somewhere in the region of 3 to 7 micrometers in the prior art.

It is important that, according to the invention, the groove depth 14 in FIG. 8a is significantly decreased vis-à-vis the prior art and represents only a fraction of the conventional groove depth. Here, the smallest groove depth 14 should correspond at the most to the width of the bearing gap.

Figure A and FIG. 8a show an idealized rectangular shape for the groove in the region of the radial bearing. For production engineering reasons, however, it would scarcely be possible to realize this kind of rectangular shape. As a rule, the edges of the rectangle are ground down. This is of no importance, however, to the crucial decrease in the groove depth.

FIG. 8b shows the height profile of the radial bearing according to the invention in accordance with FIG. 8 along the line C-C. The groove depth 14 of the bearing groove 13 can be seen as well as the bearing width of the radial bearing surface, which consists of the region of the narrow bearing gap, including the non-grooved region (land) 44 between the upper and the lower branch of the radial bearing grooves 13 and also including the non-grooved region of the quiet zone 43 axially adjoining the grooved region, provided it still has a narrow bearing gap. Considered not to belong to the actual radial bearing surface, however, are the separator region 32 and the transition region of the bevel or chamfer 45 since in these regions the bearing gap is clearly larger than the radial bearing gap.

FIG. 9 now shows the improvement in the transfer function of a hard disk system having the bearing pattern according to the invention having a decreased groove depth or smaller average pattern depth of the radial bearing grooves.

The figure describes a transfer function of the hard disk that basically consists of the following elements: a bearing system, a drive system, a baseplate and at least one storage disk.

If this system is now externally excited with a specific excitation frequency, it is important that the storage disk experiences the smallest possible deflection so as not to disturb the read or write operation on the storage disk.

Involved here is a normalized representation of the deflection, which (to be more precise) is calculated from the deflection distance divided by the acceleration.

On examining the transfer function according to FIG. 9, it now becomes apparent that at low excitation frequencies according to the prior art (see the broken curve) at Position 15, a relatively low deflection of the storage disk is achieved, as aimed for. This is achieved thanks to the large groove depth 14′, as shown in figure A representing the prior art.

After this maximum at Position 15, a curve minimum at Position 16 is achieved and then at higher excitation frequencies a maximum at Position 37 is reached. This means that at higher excitation frequencies, somewhere in the region of 1,000 to 2,000 Hz, an undesirably high deflection of the storage disk has to be accepted in the prior art.

At Position 15, the excitation frequency is approximately half the rotational speed of the bearing, whereas at Position 16 there is an unspecific region and at Position 37 a dependence on the rotational speed of the bearing can no longer be established, but rather:

$${f}_{0} = \frac{1}{2 π} \sqrt{\frac{K}{J}} applies ,$$

where K is the rocking stiffness of the baseplate and J the inertia of the rotor together with the storage disk, including bearing bush and stator.

On examining the transfer function in FIG. 9, it now becomes apparent that in the case of the invention, an unfavorable maximum at Position 15′ is indeed achieved in the low excitation frequency range of approximately 100 to 200 Hz. It was pointed out in the general description, however, that this kind of excitation frequency in the low range can be compensated for by appropriate servo-control mechanisms for the read/write head of the storage disk drive, so that this disadvantage does not have any serious consequences for the realization of the invention.

Improved control algorithms of the read/write head are particularly used in driving the storage disk, so that this heightened region at Position 15′ is of no real importance. The invention thus overrules the preconception of having to achieve the smallest possible storage disk deflection at low excitation frequencies.

What is important is that following after Position 16 in the direction of the higher excitation frequencies in a range of approximately 1,000 to 3,000 Hz, according to the invention there is only a much smaller increase at Position 37′.

Compared to the prior art, significantly smaller deflections of the storage disk are achieved at this position. This is important because at these high excitation frequencies, it is no longer possible to use control algorithms, which certainly function well in the frequency range of 100-200 Hz, but no longer in the higher ranges around 1500 Hz.

Thus the deflection of the read/write head of the storage disk cannot be checked by control algorithms in this range. This is where the invention comes into play, having recognized that the disadvantages of the deflection of the storage disk can be controlled in low frequency ranges by anti-shock measures and that these anti-shock measures, however, are no longer effective in the higher frequency range.

The advantage of the invention can be drawn from this, the invention showing that it is more important to minimize the transfer function at higher excitation frequencies of the overall system—such as occurs at Position 37′—than to minimize it in the low frequency range.

FIG. 10 shows the dependence of the carrying force of the bearing in relation to the eccentricity of the shaft vis-à-vis the bush. Two different bearing patterns are marked in here. The filled-in square boxes show a sliding bearing without bearing grooves, whereas the round dots show a radial bearing having the usual groove depth according to the prior art. The diagram of FIG. 10 shows the following results:

Here, the eccentricity pertains to a uniform bearing gap. When the eccentricity is multiplied by the width of the bearing gap, the deflection of the shaft from center is obtained, and this is indicated on the x-axis in FIG. 10 as the eccentricity.

This shows that at low eccentricities, the carrying force of a sliding bearing is considerably weaker than that of a radial bearing according to the prior art. In the approximate eccentricity range of between 0.0 and 0.3, the radial bearing with the usual groove depth has a better load-carrying capacity than a sliding bearing.

Bearing start-up begins at maximum eccentricity, because the bearing patterns rest on each other and touch each other.

At high eccentricity, approximately in the range of between 0.4 and 0.7, however, the load-carrying capacity of a sliding bearing is greatly superior to that of a radial bearing having the usual groove depths. This is where the invention comes into play, which, according to the invention, provides that the load-carrying capacity of the radial bearing according to the invention approximates the sliding bearing curve in FIG. 10. The considerable advantages of the invention over a radial bearing having the usual groove depth (round dot in FIG. 10) are thus clearly shown.

FIG. 11 shows the dependence of a minimum bearing gap in micrometers in relation to the rotational speed once the load-carrying capacity has been reached. Here the bearing according to the invention is compared to a bearing according to the prior art.

At a rotational speed at Position 38, the bearing according to the invention already achieves lift-off, i.e. it achieves its load-carrying capacity very quickly, whereas a conventional bearing according to the prior art only reaches this region at much higher rotational speeds at Position 39.

It can be seen that from the zero point to Position 38, the bearing gap remains the same, because after all the bearing patterns rest on one another. It is only after Position 40 that the lift-off motion of the bearing pattern according to the invention is effected and thus the load-carrying capacity of the bearing, which—as illustrated at Position 41—takes place considerably later for a conventional bearing. In the region between Position 42 and Position 40, the bearing according to the invention first lifts off at an incline in relation to the bearing gap, in order to then straighten up, whereas this lift-off motion between Position 42 and 41 for a bearing of the prior art takes considerably longer.

This diagram assumes that the shaft lies horizontally so as to be able to show the bearing conditions in the illustrated form.

The present technical teaching thus provides the important advantage that, according to the diagram in FIG. 9, the bearing remains stable even at higher excitation frequencies and does not transfer the excitation shocks to a storage disk or to a read/write head of a storage disk.

A further advantage of the invention is the considerable reduction in wear, which, due to the improved start-up and run-down behavior, results in a significantly longer useful life of the bearing. Tests have shown that the useful life of a bearing given decreased groove depths and having appropriate radial bearing patterns is greatly extended compared to a conventional bearing having deeper bearing patterns.

### Key to Drawings

1 Bearing
2 Inner bearing ring
3 Outer bearing ring
4 Axial bearing plate top
5 Axial bearing plate bottom
6 Middle bearing ring
7 Upper axial bearing
8 Lower axial bearing
9 Bearing pattern (radial bearing)
10 Radial bearing
11 Bearing gap (radial)
12 Capillary seal
13 Bearing groove
14 Groove depth
15 Position 15′
16 Position
17 Bearing bush
18 Shaft
19 Thrust plate
20 Hub
21 Limiting ring
22 Cover plate
23 Stator unit
24 Coil winding
25 Rotor magnet
26 Rotor back yoke
27 Baseplate
28 Axial bearing (fluid)
29 Axial bearing (magnet)
30 Upper radial bearing
31 Lower radial bearing
32 Separator region
33 Recirculation channel
34 Stationary shaft
35 Upper axial bearing (fluid)
36 Lower axial bearing (fluid)
37 Position
38 Position
39 Position
40 Position
41 Position
42 Position
43 Quiet zone
44 Land region
45 Bevel/chamfer
46 Ring

1. A radial fluid bearing having improved wear properties in the operating state of start-up and run-down, bearing patterns (9) being formed in the region between a bearing bush and a shaft (18) engaging through the bearing bush and consisting of a plurality of grooves (13, 13a, 13b, 13c) disposed at a distance from one another, characterized in that the groove depth (14) of the bearing grooves (13a, b, c) is smaller than the average bearing gap in the region of the radial bearing.

2. A radial bearing according to claim 1, characterized in that at least the groove depth (14) of the radial bearing (10) is less than 3 micrometers.

3. A radial bearing according to claim 2, characterized in that the groove depth (14) is greater than 0 micrometers.

4. A radial bearing according to claim 1, characterized in that the groove width is approximately 100 to 200 micrometers.

5. A radial bearing according to claim 1, characterized in that the groove depth (14) is deeper than the natural roughness produced by the manufacturing process.

6. A radial bearing according to claim 1, characterized in that for the arrangement of an upper radial bearing (30) and a lower radial bearing (31) disposed at a distance thereof, a non-grooved separator region (32) is formed between these two radial bearings.

7. A radial bearing according to claim 6, characterized in that the separator region (32) forms a larger bearing gap than the bearing gap in the region of the radial bearing (30, 31).

8. A radial bearing according to claim 6, characterized in that the radial bearings (30, 31) form bearing patterns (9) that are asymmetric with respect to each other.

9. A radial fluid bearing having improved wear properties in the operating state of start-up and run-down, the bearing patterns (9) being formed in the region between a bearing bush and a shaft (18) engaging through the bearing bush and consisting of a plurality of grooves (13, 13a, 13b, 13c) disposed at a distance from one another, characterized in that the average pattern depth of the grooves, which is defined as the quotient of the sum of the volume of all the grooves of a radial bearing divided by the radial bearing surface, is less than a micrometer.

10. A radial bearing according claim 9, characterized in that the average pattern depth of the grooves is less than one-half micrometer.
